(19) United States
(12) Patent Application Publication
(10) Pub. No.: US 2005/0121149 A1
(43) Pub. Date: Jun. 9, 2005

(54) Window blinds slat structure

(76) Inventors: Chin-Chang Shih, Changhua (TW); Chin-Tien Huang, Changhua (TW)

Correspondence Address: RABIN & BERDO, P.C.;Suite 500, 1101 14th Street, N.W., Washington, DC, 20005, US

(21) Appl. No.: 10/727,542

(22) Filed: Dec. 5, 2003

(51) Int. Cl. E06B 3/12

(52) U.S. Cl. 160/236

(57) ABSTRACT

A window blinds slat structure that consists of a knitted fabric, with loops unitarily knitted from the warp yarns or the weft yarns at predetermined intervals apart along the two sides of the slat, the loops enabling the insertion and positioning of long rods at the two sides of the slats. The long rods are inserted such that they are exposed outside the slats, with the slats and the long rods paired in different color combinations for a contrastive, multi-layer look that enhances the aesthetic appearance of the window blinds.

### BACKGROUND OF THE INVENTION

1) Field of the Invention

The invention herein relates to window covering products, specifically a window blinds slat structure that provides for use on doors and windows in which an original, innovative windows blinds slate structure enables products of higher quality and greater added value.

2) Description of the Prior Art

Conventional window blinds are comprised an upper support, a lower support, and a plurality of slats. Since the slats are plain surfaced and the design is uninteresting, the resulting weave design is limited and insufficiently variable to meet market requirements.

In view of the said situation, the applicant of the invention herein researched and developed a window blinds slat structure of novel design having product manufacturing utility, originality, and progressiveness which culminated in the development of the window blinds slat structure of the invention herein.

### SUMMARY OF THE INVENTION

The objective of the invention herein is to provide a window blinds slat structure utilized as a horizontal louvered window shade in which a plurality of loops are unitarily knitted from warp yarns or weft yarns along the two sides of each slat, the loops providing for the insertion and positioning of long rods, thereby converting the original conventional cloth covered slats into changeable yarn woven slats and enabling the insertion of the long rods such that they are exposed outside the slats, with the slats and the long rods paired in different color combinations for a contrastive, multi-layer look that enhances the aesthetic appearance of the window blinds, which is the primary purpose of the present invention.

Yet another objective of the invention herein is to provide a window blinds slat structure in which the said window blinds slats can be utilized on Roman blinds, wherein a plurality of loops are unitarily knitted from warp yarns or weft yarns along the two sides of the slat and the twisted threads of a fringe extend downward in an intricate array from the one side of the slat; situated at the anterior extent of the loops, the fringe covers the space between adjacent slats such that after the slats are closed, no translucence occurs at the interstices, the said structure effectively serving as a sunshade.

### BRIEF DESCRIPTION OF THE DRAWINGS

FIG. 1 is an isometric drawing of the window blinds slat structure of the invention herein.

FIG. 2 is an isometric drawing of the another window blinds slat structure embodiment of the invention herein.

FIG. 3 is an exploded drawing of the window blinds slat of the invention herein.

FIG. 4 is an isometric drawing of the window blinds slat of the invention herein.

FIG. 5 is an isometric drawing of the window blinds of the invention herein.

### DETAILED DESCRIPTION OF THE INVENTION

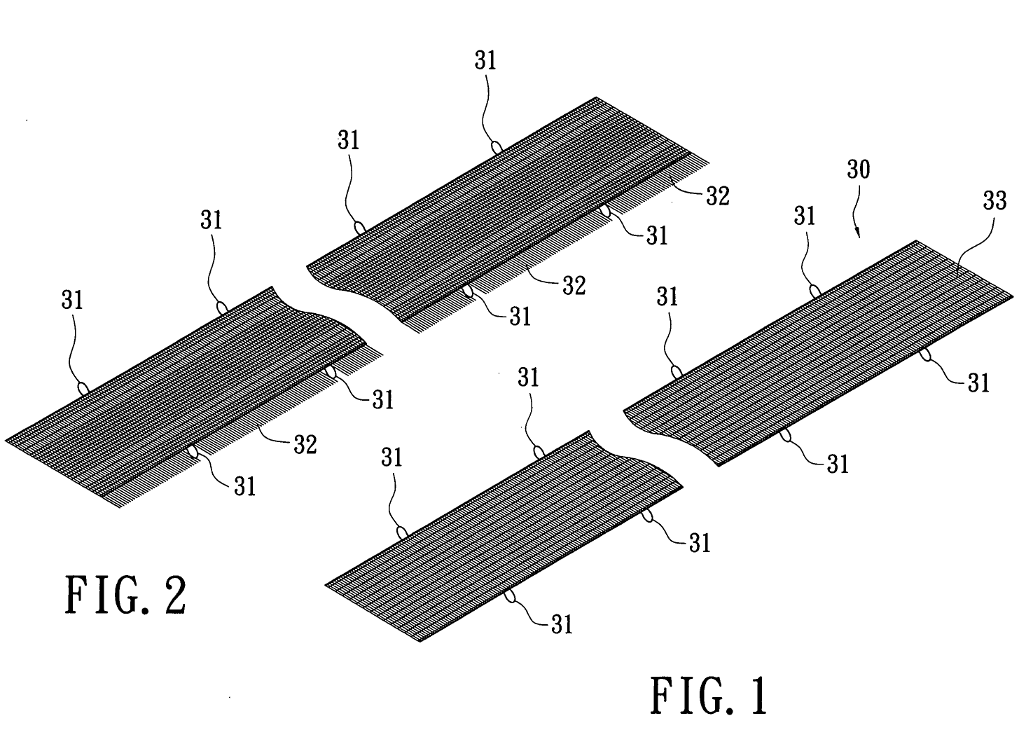

Referring to FIG. 1, the isometric drawing of the window blinds slat of the invention herein, the window blinds slat 30 structure of the present invention consists of a knitted fabric, wherein the warp yarns and weft yarns are interlaced to form intricate lattice 33 lines, the slat 30 decorative pattern achieved by varying the intervallic distance and width dimensions between each lattice 33, and loops 31 are unitarily knitted from the warp yarns or the weft yarns at predetermined intervals apart along the two sides of the slat 30.

Referring to FIG. 2, the drawing illustrating utilization on a Roman blinds slat structure, a plurality of loops 31 are unitarily knitted from warp yarns or weft yarns along the two sides of the slat 30, the twisted threads of a fringe 32 extend downward in an intricate array from the one side of the slat 30; the fringe 32 is situated at the anterior extent of the loops 31, with the fringe 32 covering the space between adjacent slats 30 such that after the slats 30 are closed, no translucence occurs at the interstices, the said structure effectively serving as a sunshade.

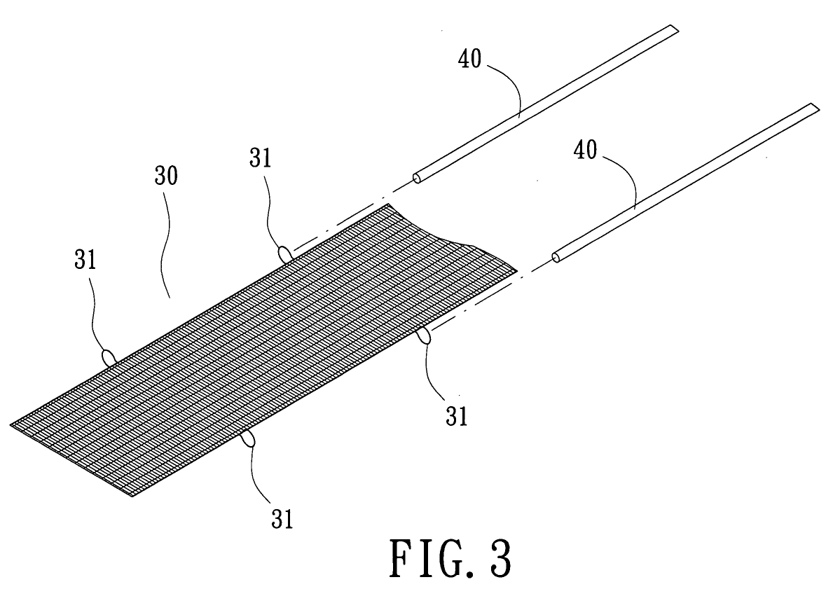

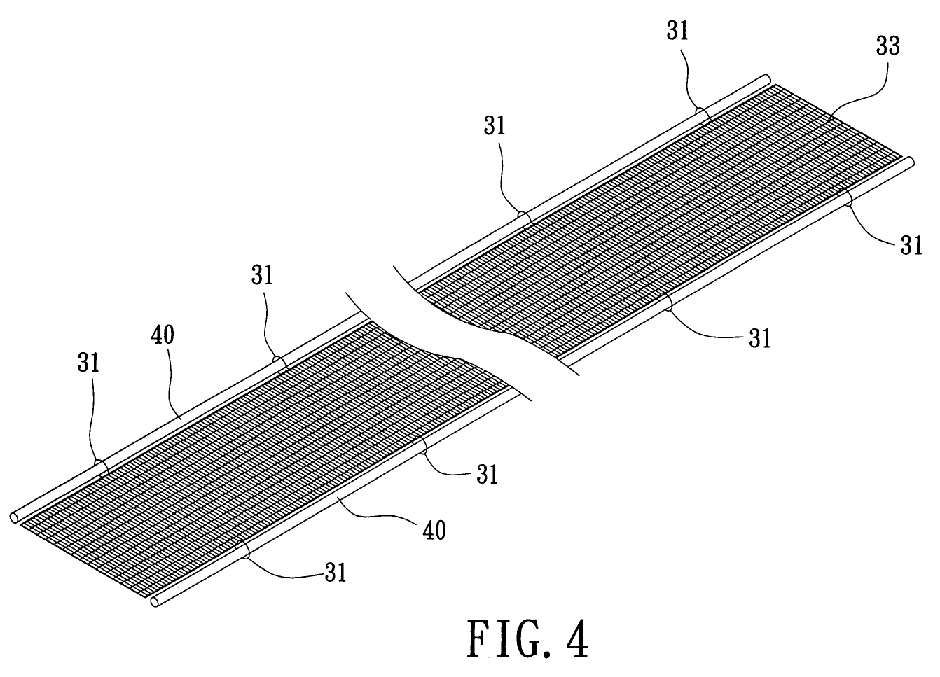

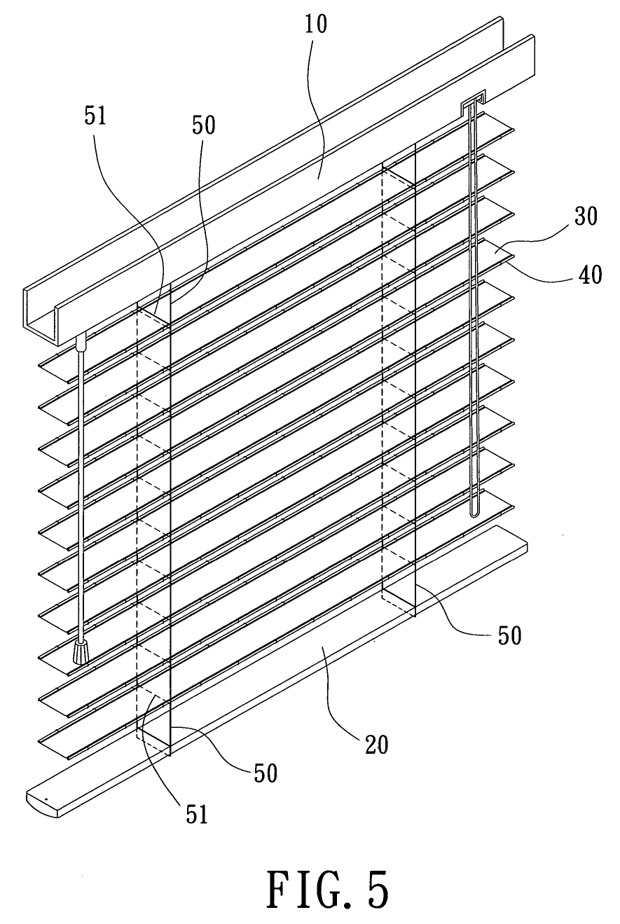

Referring to FIG. 3. FIG. 4, and FIG. 5, the invention herein as utilized on a window blinds embodiment, the example application elaborated below: First, the said window blinds is comprise of:

An upper support 10 having a control mechanism for varying slat 30 angle and adjusting lower support 20 height.

A lower support 20 situated below the upper support 10.

A plurality of window blind slats 30 having loops 31 unitarily knitted from the warp yarns or the weft yarns at predetermined intervals apart along two sides, the quantity of loops 31 increased or decreased as required.

Several long rods 40 that are individually inserted into the loops 31 at the two sides of the slats 30, each long rod 40 fabricated of a hard but flexible plastic fiber.

Several ladders 50, each connected to the said upper support 10 and the said lower support 20 and distributed along the two lateral edges of each said slat 30 and, furthermore, each said ladder 50 has two crosspiece cords 51 disposed at predetermined intervals apart, the quantity of which are equal to the amount of slats 30; when assembled, the first slat 30 is inserted between two crosspiece cords 51 (in the drawing, the area between the solid line and the invisible line), the remaining slats 30 then straddled on the two crosspiece cords 51 above (in the drawing, the invisible line area), enabling the opening and closing of each slat 30 by means of the ladder 50; said assembled components constituting a horizontal louvered window screen.

Additionally, if the problem of insufficiently level slats 30 is encountered, mounting components are installed at the two extremities of the long rods 40, the mounting components are clipped onto the slats 30 to support them horizontally and thereby eliminate the insufficiently level slats 30 problem.

When the said window blinds structure is installed, the said long rods 40 are disposed outside the slats 30 and to improve the shortcoming of the prior art, the necessity of concealing the long rods 40, the long rods 40 are colored to match slats 30 of different color to create a range of variegated combinations, the contrastive light and dark hues giving the window blinds a multi-layered look that enhances the aesthetic appearance of the window blinds, which is among the major effects of the invention herein.

In summation of the foregoing section, since the window blinds slat structure of the invention herein has manufacturing utility and, furthermore, is original and progressive, the present invention meets new patent application requirements. However, the said description only discloses the most preferred embodiment and shall not be construed as limitation on the scope and claims of the invention herein. Furthermore, all modifications and adaptations based on the application claims of the present invention shall remain protected under the claims of the invention herein.

1. A window blinds slat structure that consists of a knitted fabric, with loops unitarily knitted from the warp yarns or the weft yams at predetermined intervals apart along the two sides of the slat, the said loops enabling the insertion and positioning of long rods at the two sides of the said slat.

2. As mentioned in claim 1 of the window blinds slat structure of the invention herein, the said loops along the two sides of the said slat have dimensions that are slightly larger than the diameters of the said long rods.

3. As mentioned in claim 1 of the window blinds slat structure of the invention herein, a plurality of said loops are unitarily knitted from warp yarns or weft yarns along the two sides of the said slat and the twisted threads of a fringe extend downward in an intricate array from the one side of the said slat; the said fringe is situated at the anterior extent of the said loops, with the said fringe covering the space between adjacent said slats such that after the said slats are closed, no translucence occurs at the interstices, the said structure effectively serving as a sunshade.
